(19) United States
(12) Patent Application Publication
(10) Pub. No.: US 2014/0238993 A1
(43) Pub. Date: Aug. 28, 2014

(54) TRASH CAN WITH NESTED BAG GRIPPER

(71) Applicant: Lindsey Andersen, Atlanta, GA (US)

(72) Inventor: Lindsey Andersen, Atlanta, GA (US)

(21) Appl. No.: 13/779,364

(22) Filed: Feb. 27, 2013

(51) Int. Cl. B65F 1/14

(52) U.S. Cl. CPC B65F 1/14
USPC 220/495.06

(57) ABSTRACT

A nested trash bag dispenser system that includes nested bags and a trash can with a gripper connected to the bottom of the trash can that grips and holds the bottoms of the nested bags. The gripper holds the underlying bags in position in the trash can when the top-most bag is removed to empty the trash.

### TECHNICAL FIELD

The present invention is directed to trash receptacles and, more particularly, to a trash can suitable for household use with a nested bag gripper located in the bottom of the trash can to allow nested bags to be removed one at a time without pulling another underlying bag out of position.

### BACKGROUND

Nested bags are available for trash cans that allow several bags to be placed in the can at one time. The bags are then removed one at a time for trash remove. When the top bag is removed, the remaining nested bags remain behind to be used subsequently, which avoids the need to place a new bag in the can each time the trash is emptied.

Current nested bag systems experience a drawback when the immediately underlying bag, or multiple bags, tend to be pulled out of the can along with the top bag being removed to empty the trash. This problem is exacerbated by a vacuum effect between nested bags, static electricity, tight packing, and in some cases perforated seams holding the bottoms of the nested bags together, which results in the underlying bags being consistently pulled out of the can with the top bag. This requires the person emptying the trash to hassle with pushing the underlying nested bags back into position in the trash can, which undermines much of the convenience of the nested bag approach.

Certain trash cans have been developed with tabs, cleats or pins on the outside or near the top of the trash can to hold the underlying nested bags in place when the top bag is removed. But this approach does not work particularly well because the lower portions of the underlying bags can still be pulled out of the can. As a result, a need exists for an improved nested trash bag system.

### SUMMARY

The present invention solves the problems described above in a trash bag dispenser system that includes nested bags and a trash can with a gripper connected to the bottom of the trash can that grips and holds the bottoms of the nested bags. The gripper securing the bottoms of the nested bags to the bottom of the trash can allows the top-most bag to be removed without pulling the underlying nested bags out of the can. The bottom gripper is easy to use yet particularly effective at preventing the underlying bags from being pulled out of the trash can even when the nested bags are tightly packed forming a vacuum between the bags during removal of the top bag and when the bottoms of the nested bags are connected to each other by perforated seams.

### BRIEF DESCRIPTION OF THE DRAWINGS

FIG. 1 is cut-away view of a trash can with a gripper located in the bottom of the trash can for gripping and holding the bottoms of nested bags.

FIG. 2 is top view of the trash can showing a first gripper configuration.

FIG. 3 is top view of the trash can showing a first second configuration.

FIG. 4 is cut-away new of the trash can with the bottom portions of a supply of nested bags held within the in the gripper.

FIG. 5 is cut-away view of the trash can with the gripper holding the underlying nested bags in position while the top-most bag is removed to empty the trash.

FIG. 6 is cut-away view of the trash can in which the gripper in located on a reservoir holding a replacement supply of nested bags.

### DETAILED DESCRIPTION OF THE INVENTION

The present invention may be embodied in a nested trash bag system that includes a trash can with a gripperbuilt into the interior, bottom surface of the trash can. The bags will typically come nested in a group of about 10 at bags, nested inside each other, so that the bottoms or tips of the bags sit inside one another. When the user pulls out the top bag, the other remaining bags stay in place, because the gripper is holding the other 9 bags to the bottom of the trash can.

The gripper may be made of plastic or soft rubber like material, so that nothing sharp can puncture the bag. To allow all the underlying bags to stay in place, the gripper applies a very light grip at the bottom, similar to but stronger than a tissue box, letting one tissue at a time go. This is an improvement upon currently available nested bag system without a gripper at the bottom to hold the remaining bags in place. The current system does not work very well, due to the fact that when the user pulls up the bag with trash, the next bag (or multiple bags) comes up with it. Then the user has to push the rest of the bags back down. This is because there is nothing at the bottom holding the nested bags in place.

Bags will come in a group of 10 nested inside one another, and all they user will have to do, is stick the group of 10 in the trash can, and place the bag bottoms in the gripper, and the user will have 9 times to pull out the top bag of trash, and have the next bag already in place. This system makes it so that the user very seldom has to go find the supply of bags, because 9 times out of 10 the replacement bag will already be there, open and ready for use. Not only will the user not have to go find the next trash bag, the user will not have to shake open the bag. In addition, the user will also not have to fold the next bag over the side of the trash can. The user will also not have to get the air out of the sides of the bag, which typically happens when placing a new bag in the trash can. The nested bag system with the bottom bag gripper eliminates a lot of steps associated with “taking out the trash” most of the time.

Referring to FIG. 1, the present invention may be embodied in a nested trash bag system 10 that includes a trash can 12 with a gripper 14 built into the interior, bottom surface of the trash can. Alternatively, the gripper 14 may be formed separately and attached to any trash can with a sufficiently flat bottom. The separate gripper can be installed during manufacturing or sold separately as a retrofit or after-market part for installation the user typically with strong, waterproof glue carried on the gripper. The built-in or manufacturer installedgripper may be preferred by most users to ensure that the gripper remains permanently attached to the trash can and cannot come loose with use over time.

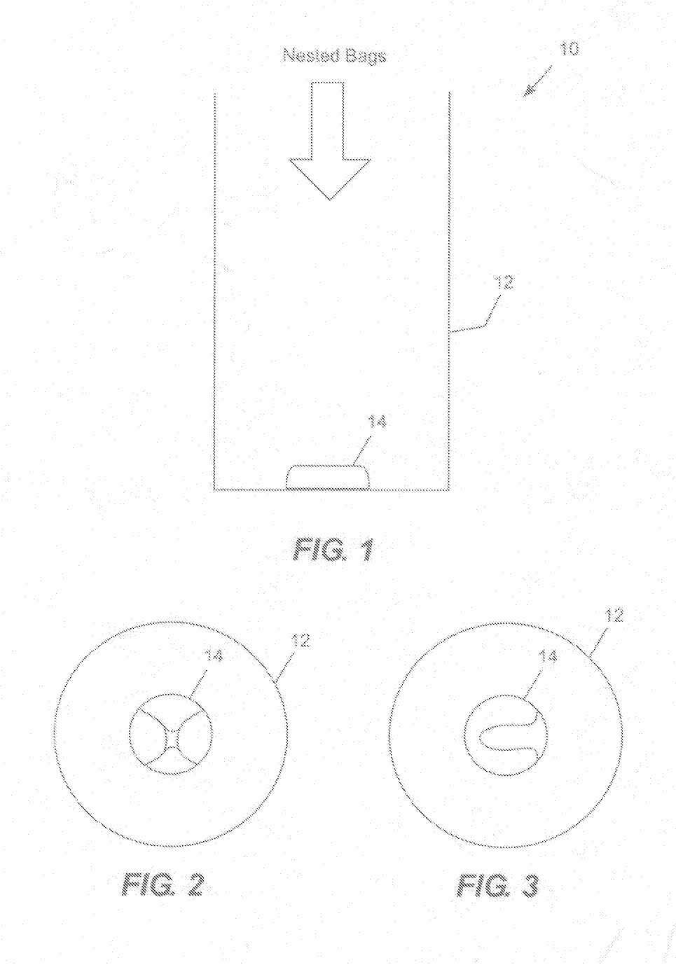

As shown in FIG. 2, the gripper 14 may include pliable flaps configured to allow the user to easily poke a bunched up portion of the nested bag bottoms into the gripper. FIG. 3 shows an alternative gripper 14 configured to allow the user to easily slide the bunched up portion of the nested bag bottoms into the gripper. While these illustrative grippers age believed to be the inexpensive, effective and easy to use, other gripper configurations may be used, such as a spring clip, a pin that is inserted through a preconfigured hole in the nested bag bottom portion, and articulating cleat similar to that used as boating tackle, or any other suitable type of fastener.

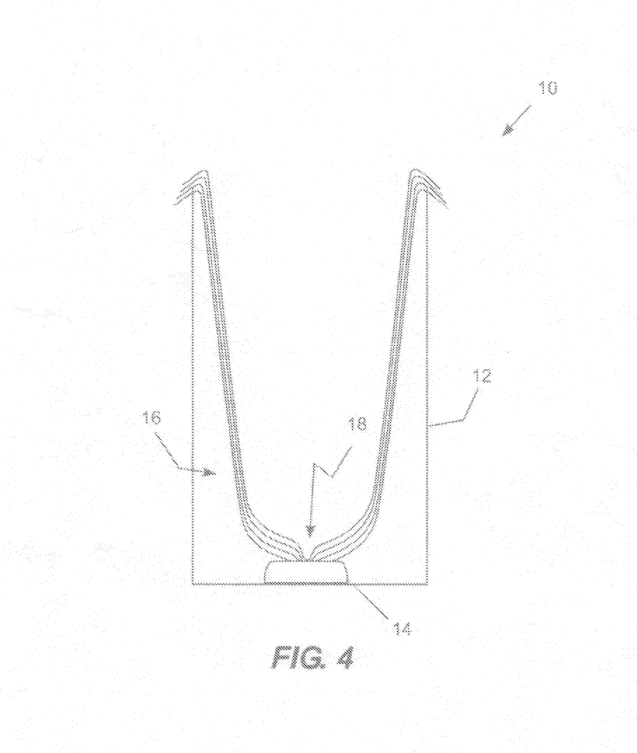

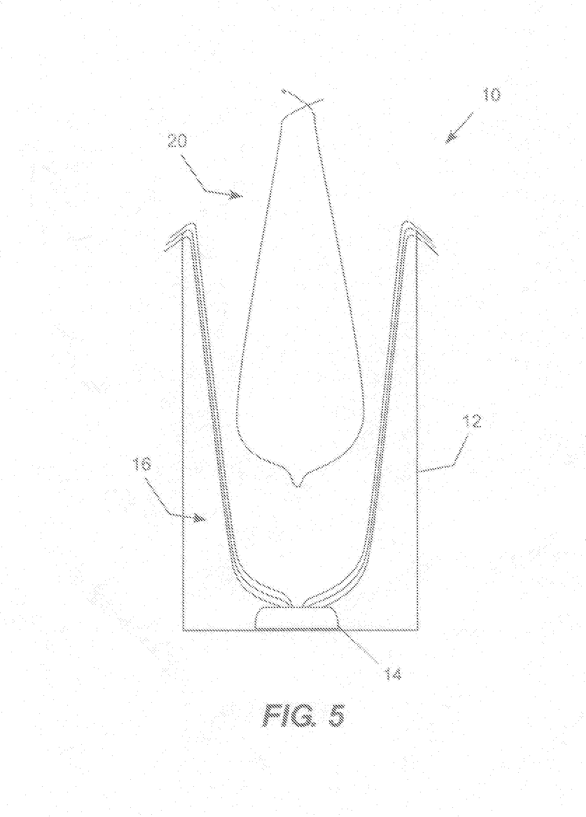

Referring to FIG. 4, the gripper 14 is typically configured to hold a group of about 10 nested bags 16 (or 6, 12, 18 or any other suitable number). The group of nested bags 16 is placed into the trash can with the top ends extending over the top edge of the trash can, just link a single bag is normally placed in the can. The gripper is configured to work well with ordinary trash bags that have not been specially designed to work with the gripper. The center portions of the bottoms of the nested bags are bunched together and placed into the secured position in the gripper. The bunched portions of the bags are nested inside each other so that a portion each bag is positioned in the gripper. Specially designed bags may also be used to further the ease of placing the bags into position in the gripper. For example, the bags may each include a protruding tip 18 at the bottom of the bag configured to cooperate with the gripper to facilitate poking or sliding tips into the. The tips are nested inside each other so that the complete group of nested tips is easily positioned in the gripper. The bottom portion of the bags or tip could also include a hole for receiving pin type cleat or a spring clip fastener, be shaped to form a tab for receipt in an articulating cleat, or another feature specifically designed to cooperate with a particular type of gripper utilized.

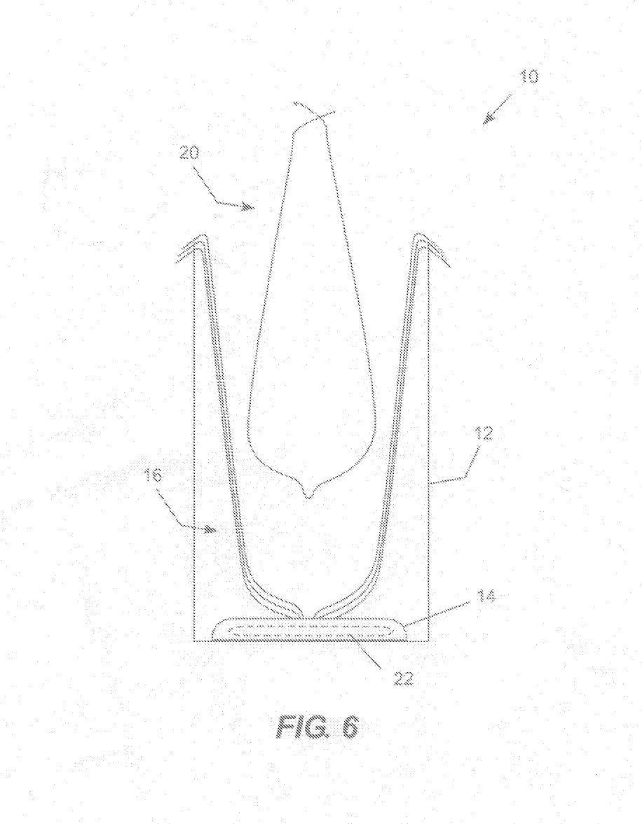

Referring to FIG. 5, the group of nested bags 16 is placed into the trash can 12 with portions of the bottoms of the bags positioned in the gripper 14. This holds the underlying nested bags in position in the trash can when the top-most bag 20 is removed to empty the trash. When all of the nested bags have been used, a new supply of nested bags is placed in the trash can. This reduces the number of times that the user has to place new bags in the trash can by a factor equal to the number of bags in the nested groups. Referring to FIG. 6, the gripper may be located on a “false bottom” or box-like structure forming a reservoir for holding a replacement supply of nested bags 22.

It should be appreciated that the gripper does not require a hole through the bottom of the trash can, which could pose a leak potential. It should be further appreciated that the gripper, which is typically located in the center of the bottom of the trash can, does not interfere with foot-pedal operated lid lifting mechanisms. The trash can may also include a second bottom surface or a box like reservoir at the bottom of the trash can for holding a replacement supply of nested bags, further improving the convenience of the design. The bag reservoir and the gripper may be incorporated into the same structure, so that bunched portions or tips of the bags go into the top of the reservoir.

The invention claimed is:

1. A nested trash bag system comprising:
a trash can having an interior bottom surface;
a gripper connected to interior bottom surface of the trash can configured to receive and grips portions of bottoms of a group of nested bags placed in the trash can;
wherein the gripper is configured to hold underlying bags of the group of nested bags in position in the trash can when a top-most bag of the group of nested bags is removed to empty trash from the trash can.

2. The nested trash bag system of claim 1, further comprising a supply of nested bags configured to be located in the trash can with portions of the bottoms of the bags positioned within the gripper.

3. A group of nested trash bags configured to cooperate with a trash can configured to receive the nested trash bags, wherein each bag includes a bottom comprising a tip configured for receipt by a gripper located on a bottom interior surface of a trash can, and wherein the tips are nested within each other
